(19) United States
(12) Patent Application Publication
(10) Pub. No.: US 2013/0327793 A1
(43) Pub. Date: Dec. 12, 2013

(54) METHOD OF MANUFACTURING AND FILLING KEGS WITH BEER IN A KEG FILLING PLANT, WHICH KEG FILLING PLANT IS DISPOSED WITHIN A SINGLE BUILDING

(71) Applicant: Alois MONZEL, Morstadt (DE)

(72) Inventor: Alois MONZEL, Morstadt (DE)

(73) Assignee: KHS GMBH, Dortmund (DE)

(21) Appl. No.: 13/899,862

(22) Filed: May 22, 2013

Related U.S. Application Data
(63) Continuation-in-part of application No. 12/752,710, filed on Apr. 1, 2010.

(51) Int. Cl. B67D 1/08

(52) U.S. Cl. CPC B67D 1/0829
USPC 222/542; 53/452

(57) ABSTRACT

A method of manufacturing and filling kegs with beer in a keg filling plant, which keg filling plant is disposed within a single building. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### CONTINUING APPLICATION DATA

This application is a Continuation of U.S. patent application Ser. No. 12/752,710, filed on Apr. 1, 2010, which is Continuation-In-Part application of International Patent Application No. PCT/EP2008/002137, filed on Mar. 18, 2008, which claims priority from Federal Republic of Germany Patent Application No. 10 2007 047 060.8, filed on Oct. 1, 2007. U.S. patent application Ser. No. 12/752,710 was pending as of the filing date of this application. The United States was an elected state in International Patent Application No. PCT/EP2008/002137.

### BACKGROUND

1. Technical Field

The present application relates to a method of manufacturing and filling kegs with beer in a keg filling plant, which keg filling plant is disposed within a single building.

2. Background Information

Background information is for informational purposes only and does not necessarily admit that subsequently mentioned information and publications are prior art.

Some containers utilized for holding liquids have fittings. Some containers used to hold liquid beverages have fittings. Some containers are disposable with disposable fittings made of plastic and/or stainless steel and/or other material or combinations of materials.

The present application relates to a method of providing a fitting on a container in a filling plant. The fitting is provided with a riser tube which extends into the container. In this process, the respective fitting is made available. Then, the riser tube of the desired length is made available. In the next step, the riser-tube-forming length is connected to the respective fitting. Then, the fitting is positioned on the container, the riser tube being introduced into the container interior. Finally, the fitting is connected to the container. The present application also relates to a container, in one possible embodiment a disposable container with a fitting fixed on a container mouth with a riser tube projecting from the fitting into the container, wherein the riser tube is formed from a length separated from a stock of a tubular or hose-like starting material.

### OBJECT OR OBJECTS

An object of the present application is to present a method which makes it possible efficiently to provide containers, on their container openings, with fittings which have riser tubes.

### SUMMARY

The present application seeks to achieve this object with a method of providing a fitting on a container, the fitting being provided with a riser tube which extends into the container, comprising the following steps, which are conducted at the filling plant: making available the respective fitting, making available a riser tube of the desired length, connecting the riser-tube-forming length to the respective fitting, positioning the fitting on the container with the riser tube being introduced into the container interior, and connecting the fitting to the container. The present application seeks to achieve this object also with a container, in one possible embodiment a disposable container, with a fitting fixed on a container mouth with a riser tube projecting from this into the container, wherein the riser tube is formed from a length separated from a stock of a tubular or hose-like starting material. In one possible embodiment of the present application, the respective fitting is provided immediately prior, substantially immediately prior, essentially immediately prior, or prior to its use with the riser tube, i.e. immediately before, substantially immediately before, essentially immediately before, or before being attached to the container or to the container area including the container opening (e.g. container head) and the tube is hereby taken from a stock of prepared riser tubes (including those of different lengths) or is produced by drawing out and separation from a stock of tubular or hose-like starting material. This completion of the respective fitting with the riser tube occurs in each case at the premises of the user or at the filling plant, whereby the filling of the respective container with the filling takes place either via the fitting fixed onto the container or else prior to attachment of the fitting and/or closure of the container with the fitting.

It is possible e.g. to use fittings of one and the same design for containers of different sizes or filling volumes, in which case the length of the riser tubes is adjusted to the respective container size by corresponding selection from a stock or by corresponding separation from the starting material.

The word “fitting” in the sense of the present application means fittings which have the design known to the person skilled in the art, i.e. are designed in such a way that they can at least be used for the removal of the liquid from the respective container, but also if desired the respective container can be filled via the fitting.

Refinements, possible embodiments, and possible applications of the present application will become apparent from the following description of embodiments and from the figures. The features described and/or graphically illustrated per se or in any combination are a fundamental subject matter of the present application, regardless of their back references.

The above-discussed embodiments of the present invention will be described further herein below. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

The present application will next be explained in more detail with the aid of the figures on the basis of one embodiment:

FIG. 1 shows, in highly simplified diagrammatic view, a container, for example in the form of a large-capacity plastic container with a fitting provided at the mouth of the container;

FIGS. 2A, 2B, and 2C show various process steps for the production of the container with the fitting; and

FIG. 3 shows a block diagram of one possible embodiment of the present application.

### DESCRIPTION OF EMBODIMENT OR EMBODIMENTS

In the figures, 1 is a container, for example a large-capacity or keg-type container for holding a liquid. The container 1, which is manufactured e.g. from plastic, for example from PET (Polyethylene terephthalate), is designed in known fashion with, on its container top, a head area 2 forming the container mouth, on which a fitting 3 is fastened in appropriate fashion.

The fitting 3, which is produced, for example, as a disposable fitting made of plastic, and/or stainless steel and/or another material or composite and/or another material combination, comprises the functional elements known to the person skilled in the art, via which e.g. it is possible to fill the container 1 provided with the fitting with a liquid using the usual filling machines or techniques, and also, in one possible embodiment, to remove the liquid from the container 1.

The fitting 3 is furthermore provided with a riser tube 4 which extends from the container head and/or fitting 3 in the direction of the container base 5 in the container's interior.

In at least one possible embodiment of the present application, the fitting 3 is provided with the riser tube at the time of use, i.e. at the filling plant. To this end, e.g. to form the riser tube 3, a length corresponding to the longitudinal dimension of the riser tube 4 is separated, immediately prior to the attachment of the fitting 3 onto the container head 2 or immediately prior, substantially immediately prior, essentially immediately prior, or prior to the filling of the container 1, from a stock of a tubular or hose-like starting material, for example a starting material made of plastic or metal, and connected to the fitting 3.

Furthermore, there is the option of likewise connecting the respective fitting 3 just prior to use, i.e. at the filling plant, with a riser tube of the desired length, which is held in readiness in a stock comprising several riser tubes 4.

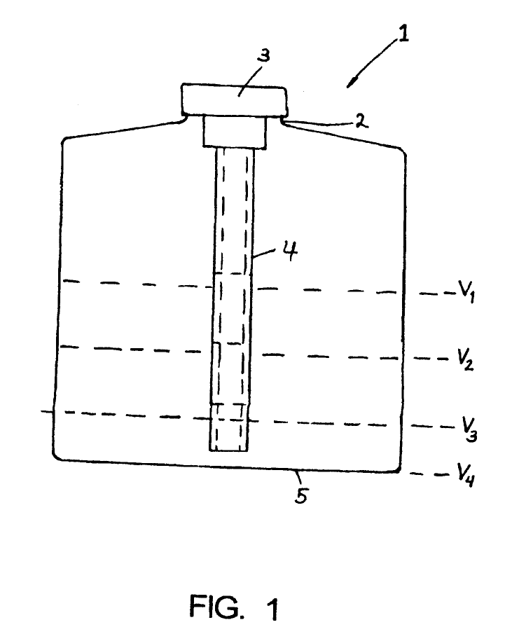

The respective riser tube 4, when one and the same fitting 3 is used, can be adapted without any problem to different filling volumes, i.e. to different container sizes or heights, as indicated in FIG. 1 by the broken lines V1-V4. The use of the same fittings for different containers and sizes of container simplifies manufacture, reduces manufacturing costs through greater manufacturing volumes, and also simplifies storage or stock-keeping, both for the manufacturer of the fittings 3 and for the user (filling plant).

The respective riser tube 4 can be attached to the fitting 3 in a wide variety of ways, for example by gluing, welding or in other appropriate ways.

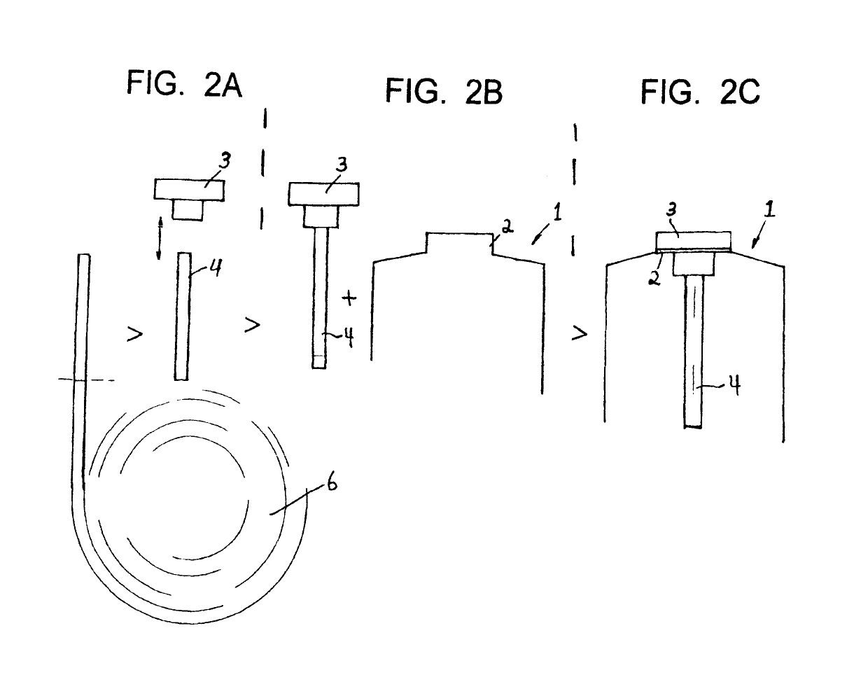

FIGS. 2A, 2B, and 2C show again the method steps of a method according to the present application. Firstly, according to the position shown in FIG. 2A, the respective fitting 3 and a length separated from the stock of starting material 6 forming the riser tube is made available. According to the position shown in FIG. 2B, the fitting 3 and the length forming the riser tube 4 are connected together and then the fitting 3 provided with the riser tube 4 is fixed onto the container head 2, so that finally, according to the position shown in FIG. 2C, the container 1 provided with the fitting is obtained. The filling of the container with the liquid then takes place either with the fitting 3 mounted on the container 1 or else prior to the closure of the container 1 with the fitting 3.

The method steps shown in FIGS. 2A, 2B, and 2C are, in one possible embodiment, carried out in a corresponding device or plant, which then has means for feeding the fittings 3, for drawing out and separating the respective length of the starting material 6 desired for the riser tube or to provide the respective riser tube 4 with the desired length, for bringing together and connecting the fitting 3 with the riser tube 4 and for inserting the riser tube 4 and connecting the fitting 3 with the container head 2.

In one possible embodiment of the method of the present application, the fittings 3 may be standardized for use with a variety of kegs or containers 1. For example, one fitting 3 may be utilized or used with kegs 1 of different volumes and/or sizes. In one possible embodiment of the present application, one standardized fitting 3 may be connectable to both a twenty-five-liter keg and a fifty-liter keg. In other possible embodiments of the present application, the standardized fitting 3 may also be connectable to kegs of additional sizes and/or volumes, such as twenty-liter kegs, thirty-liter kegs, and other volumes.

In one possible embodiment of the present application, the riser tube 4 may also be a spear 4. A spear 4 may comprise a tube. A spear 4 also may comprise a valve and/or fitting 3. In one possible embodiment, the riser tube 4 and fitting 3 may comprise a spear. In another possible embodiment, the riser tube 4, with or without the fitting 3, may comprise a spear.

In the method according to one possible embodiment of the present application, a keg filling plant may be utilized to fill kegs with a beverage material, such as beer. This keg filling plant may be utilized to fill kegs of different sizes, diameters, heights, and/or volumes. For example, a first run of kegs may be filled with a beverage material, such as beer. In the first run of kegs, the kegs may be of a first size. Upon filling the first run of kegs, the machinery of the keg filling plant may then be adjusted to fill a second run of kegs. In the second run of kegs, the kegs may be of a second and/or different size than the first size of kegs filled during the first run. The machinery may have been adjusted for the second run of kegs in order to provide a length of riser tube and/or spear for the kegs of a second size, during the filling of the second run of the kegs. The length of the riser tube and/or spear for the second-sized keg is different from the length for the first-sized keg. The difference in length of the spear between the first keg and the second keg may be longer or shorter.

In one possible embodiment of the present application, the spears 4 may comprise a plastic material, for example PET. In another possible embodiment of the present application, the spears 4 may comprise a metal. In other embodiments, the spears 4 may comprise another material. In one possible embodiment of the present application, the fittings 3 may comprise a plastic material, for example PET. In another possible embodiment of the present application, the fittings 3 may comprise a metal. In other embodiments, the fittings 3 may comprise another material.

In at least one possible embodiment of the present application, the keg 1 may comprise metal. In another possible embodiment, the keg 1 may comprise plastic, such as PET. In another possible embodiment, the keg may comprise a combination of materials, such as metal, plastic, or other such materials.

In one possible embodiment of the present application, the fitting and/or coupling 3, which is connected to the riser tube or spear 4 and then connected to the keg 1, may be of the same type for both types of kegs. For example, the same type of fitting 3 may be attached and/or connected to the keg of the first size and also to the keg of the second size.

In other possible embodiments of the present application, the method may involve using fittings 3 of different types. For example, a riser tube 4 may be cut to one length, connected to a fitting 3 of a first type, and then the fitting 3 and spear 4 are connected to a keg of a first size. Then the machinery may be adjusted, such that the tube 4 may be cut to another length, connected to a fitting 3 of a second type, and then the fitting 3 and spear 4 are connected to a keg of a second size.

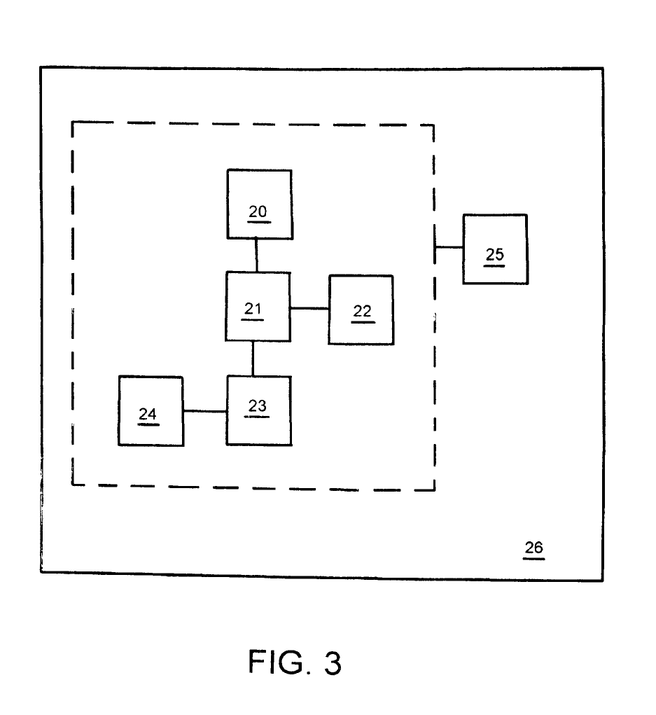

As may be seen in FIG. 3, in one possible embodiment of the present application, a computer or control device 25 may be used to calculate and/or determine the amount of time desired to make a number of spears for use with keg bodies in a keg filling plant. The computer or control device 25 may be configured and disposed to monitor and/or control the operation of the keg machinery in the keg 251 filling plant 26, for example, a riser tube cutting machine 20, a keg fitting machine 22 configured to provide fittings, a connecting machine 21 configured to connect a fitting 3 to a riser tube 4 to produce a spear, a keg filling machine 24, and a closing and connecting machine 23 configured to connect a spear to a filled keg and close the filled keg 1.

For example, the control device 25 may calculate how many kegs are to be filled with the keg filling machine 24. The control device 25 may then control the riser tube cutting machine 20 such that the riser tube cutting machine 20 may begin to cut and produce riser tubes in order to supply riser tubes 4 to the connecting machine 21, connect the tubes 4 to fittings 3 to produce finished spears, and then supply the finished spears to the closing and connecting machine 23 in time to be connected to filled kegs 1. With this method, the first finished spear and first filled keg are connected together with minimal wasted time. Likewise, the last finished spear and last filled keg are connected together with minimal wasted time.

The control device 25 may also be configured to stop production of the one type of riser tube at the riser tube cutting machine 20 and begin production of another type of riser tube in the riser tube cutting machine 20, such that there is enough lead time so the second type of riser tubes are produced with enough time to process through the connecting machine 21 and then reach the closing and connecting machine 23 upon a second type of keg also reaching the closing and connecting machine 23. The computer or control device 25 may count and/or calculate how many finished kegs may be produced during a run a first run, and then stop production of spears of a first length and begin production of spears of a second length for a second run of kegs. Prior to the start of the second run, the computer 25 may determine when to start the production of a second length of riser tubes, and then control the cutting machine 20 to begin production of the second length riser tubes. The producing of a different lengths of riser tubes may take different lengths of times. For example, shorter riser tubes may not take as long to produce as longer riser tubes, so the control device and/or computer 25 may adjust the machinery accordingly in order to maintain a predetermined production rate.

By monitoring and/or controlling the production of spears and by monitoring and/or controlling the filling of kegs with the computer 25, the ratio of produced spears to filled kegs may be kept proportional to the desired production. For example, in one possible embodiment, the computer 25 may monitor the production in order to produce one spear for every filled keg. The computer and/or control device 25 may additionally comprise sensors and/or counters to monitor the production process.

Kegs may range in various sizes and volumes. For example, a mini keg may have a volume of 1.32 U.S. gallons or five liters. A full keg, which also may be called a half-barrel, may have a volume of 15.5 U.S. gallons or 58.66 liters. Other sizes of kegs may include a home brew keg or cornelius keg with a volume of five U.S. gallons or 18.9 liters. A sixth-barrel keg may have a volume of 5.23 U.S. gallons or 19.8 liters. Other sizes of kegs may include a quarter-barrel keg or pony keg with a volume of 7.75 U.S. gallons or 29.3 liters. A slim quarter-barrel may also have a volume of 7.75 U.S. gallons or 29.3 liters. A European import keg or European barrel may have a volume of 13.2 U.S. gallons or fifty liters. A European import keg may also have a volume of thirty liters, twenty-five liters, or twenty liters. A European import keg may also have a volume of 7.93 U.S. gallons, 6.6 U.S. gallons, or 5.28 U.S. gallons. A European import may also have a volume of thirty liters, twenty-five liters, or twenty liters. A German DIN 6647-1 keg or German DIN 6647-2 keg may also have a volume of fifty liters, thirty liters, twenty-five liters, or twenty liters. A German DIN 6647-1 or DIN 6647-2 keg may have a volume of 13.2 U.S. gallons, 7.93 U.S. gallons, 6.6 U.S. gallons, or 5.28 U.S. gallons. Other various sizes or volumes of kegs may vary by any range of gallons, quarts, liters, pints, or fractions or increments thereof within the range of five liters to 58.66 liters. Other various sizes or volumes of kegs may vary by any range of gallons, quarts, liters, pints, or fractions or increments thereof within the range of 1.32 U.S. gallons to 15.5 U.S. gallons. Other various sizes or volumes of kegs may be less than 1.32 U.S. gallons or five liters. Other various sizes or volumes of kegs may be greater than 15.5 U.S. gallons or 58.66 liters.

Kegs of various sizes and volumes may also range in various heights. For example, a 1.32 gallon mini keg may have a height of 11.4 inches or twenty-nine centimeters. A three gallon keg may have a height of fourteen inches or 35.6 centimeters. A five gallon home brew or cornelius keg may have a height between twenty-two inches and twenty-five inches. A five gallon home brew or cornelius keg may have a height between 55.88 centimeters and 63.5 centimeters. A 7.75 quarter-barrel keg or “pony keg” may have a height of 13.5 inches or 34.3 centimeters. A 15.5 gallon full keg may have a height of 23.3 inches or 59.2 centimeters. A European import keg may have a height between 8.5 inches and 20.9 inches. A European import keg may have a height between 21.6 centimeters and 53.2 centimeters. A German DIN 6647-1 or German DIN 6647-2 keg may have a height between 12.2 inches and 23.6 inches. A German DIN 6647-1 keg or DIN 6647-2 keg may have a height between thirty-one centimeters and sixty centimeters. Other various kegs of various sizes and volumes may have heights that may vary by any range of feet, inches, centimeters, millimeters, steps of millimeters, or increments or fractions thereof within the range of 11.4 inches to 23.3 inches. Other various kegs of various sizes and volumes may have heights that may vary by any range of feet, inches, centimeters, millimeters, steps of millimeters, or increments or fractions thereof within the range of twenty-nine centimeters to 57.2 centimeters. Other various heights of kegs may be less than 11.4 inches or twenty-nine centimeters. Other various heights of kegs may be greater than 23.3 inches or 59.2 centimeters.

Kegs of various sizes and volumes may also range in various diameters. For example, a 1.32 gallon or five liter mini keg may have a diameter of 10.25 inches or twenty-six centimeters. A full keg or half-barrel keg may have a diameter between sixteen and seventeen inches. A full keg or half-barrel keg may have a diameter between 40.6 centimeters and 43.2 centimeters. A pony keg may have a diameter between sixteen inches and seventeen inches. A pony keg may have a diameter between 40.6 centimeters and 43.2 centimeters. A slim quarter-barrel keg may have a diameter of eight inches or 20.3 centimeters. A home brew or cornelius keg may have a diameter between eight inches and nine inches. A home brew or cornelius keg may have a diameter between 20.3 centimeters and 22.9 centimeters. A European import keg may have a diameter between 39.5 centimeters and 40.8 centimeters. A European import keg may have a diameter between 15.5 inches and 16.1 inches. A German DIN 6647-1 keg or German DIN 6647-2 keg may have a diameter between 14.2 inches and fifteen inches. A German DIN 6647-1 keg or German DIN 6647-2 keg may have a diameter between 36.3 centimeters and 38.1 centimeters. Other various kegs of various sizes and volumes may have diameters that may vary by any range of feet, inches, centimeters, millimeters, steps of millimeters, or increments or fractions thereof within the range of eight inches to seventeen inches. Other various kegs of various sizes and volumes may have diameters that may vary by any range of feet, inches, centimeters, millimeters, steps of millimeters, or increments or fractions thereof within the range of 20.3 centimeters to 43.2 centimeters. Other various diameters of kegs may be less than eight inches or 20.3 centimeters. Other various diameters of kegs may be greater than seventeen inches or 43.2 centimeters.

Barrels or casks, for example, pins, firkins, kilderkins, puncheons, hogsheads, rundlets, tierces, pipes, butts, and tuns may also range in various sizes and volumes. A pin may have a volume of 4.5 Imperial gallons or 20.45 liters. A firkin may have a volume of nine Imperial gallons or 40.91 liters. A kilderkin may have a volume of eighteen Imperial gallons or 81.82 liters. A barrel may have a volume of thirty-six Imperial gallons or 163.65 liters. A hogshead may have a volume of fifty-four Imperial gallons or 245.49 liters. A puncheon, or pon, or tertian may have a volume of seventy-two Imperial gallons or 327.32 liters. A butt may have a volume of one hundred and eight Imperial gallons or 490.98 liters. A pipe may have a volume of one hundred and twenty-six Imperial gallons or 572.8 liters. A tun may have a volume of two hundred and sixteen Imperial gallons or 981.95 liters. Other various sizes or volumes of barrels or casks may vary by any range of gallons, quarts, liters, pints, or fractions or increments thereof within the range of 20.45 liters to 981.95 liters. Other various sizes or volumes of barrels or casks may vary by any range of gallons, quarts, liters, pints, or fractions or increments thereof within the range of 4.5 Imperial gallons to two hundred and sixteen Imperial gallons. Other various sizes or volumes of barrels or casks may be less than 4.5 Imperial gallons or 20.45 liters. Other various sizes or volumes of barrels or casks may be greater than two hundred and sixteen Imperial gallons or 981.95 liters.

Barrels or casks of various sizes and volumes may also range in various heights. For example, a firkin may have a height of eighteen inches or 45.7 centimeters. A kilderkin may have a height of twenty-four inches or sixty-one centimeters. A forty gallon barrel may have a height of thirty-five inches or 88.9 centimeters. A hogshead may have a height of thirty-seven inches or ninety-four centimeters. A puncheon may have a height of 43.3 inches or one hundred and ten centimeters. A butt may have a height of fifty inches or one hundred and twenty-seven centimeters. A pipe barrel may have a height of fifty-seven inches or 144.8 centimeters. Other various heights of casks or barrels may vary by any range of feet, inches, centimeters, millimeters, steps of millimeters, or increments or fractions thereof within the range of eighteen inches to fifty-seven inches. Other various heights of barrels may vary by any range of feet, inches, centimeters, millimeters, steps of millimeters, or increments or fractions thereof within the range of 45.7 centimeters to 144.8 centimeters. Other various heights of casks or barrels may be less than eighteen inches or 45.7 centimeters. Other various heights of casks or barrels may be greater than fifty-seven inches or 144.8 centimeters.

Barrels or casks of various sizes and volumes may also range in various diameters. For example, a middle cross-section of a firkin may have a diameter of 16.1 inches or forty-one centimeters. A middle cross-section of a kilderkin may be 19.7 inches or fifty centimeters. A middle cross-section of a forty gallon barrel may have a diameter of 23.6 inches or sixty centimeters. A middle cross-section of a hogshead may have a diameter of twenty-seven inches or 68.6 centimeters. A middle cross-section of a puncheon may have a diameter of 35.4 inches or ninety centimeters. A middle cross-section of a pipe barrel may also have a diameter of 35.4 inches or ninety centimeters. A middle cross-section of a butt may have a diameter of 37.4 inches or ninety-five centimeters. Other various diameters of casks or barrels may vary by any range of feet, inches, centimeters, millimeters, steps of millimeters, or increments or fractions thereof within the range of 16.1 inches to 37.4 inches. Other various diameters of barrels may vary by any range of feet, inches, centimeters, millimeters, steps of millimeters, or increments or fractions thereof within the range of forty-one centimeters to ninety centimeters. Other various diameters of casks or barrels may be less than 16.1 or forty-one centimeters. Other various heights of casks or barrels may be greater than 37.4 inches or ninety-five centimeters.

There may be different types of keg spears, spear tubes, or riser tubes. There may be flat-type keg spears, well-type keg spears, U.S. well-type keg spears, UEC-type keg spears, and a soft drink keg spears. Keg spears, spear tubes, or riser tubes may comprise different sizes and/or types of keg valves or keg fittings. Different sizes and/or types of keg valves or keg fittings may include an A-system keg valve, a D-system keg valve, a G-system keg valve, an M-system keg valve, an S-system keg valve, a U-system keg valve, a twin probe keg valve, and a home brew keg valve. An A-system valve may also be called a German Slider keg valve. A D-system keg valve may also be called a U.S. Sankey keg valve or American Sankey keg valve. An S-system keg valve may also be called a European Sankey keg valve. A G-system may also be called a Grundy keg valve. A U-system keg valve may also be called a UEC-system keg valve or interbrew keg valve. A twin probe may also be called be called a Hoff Stevens keg valve. A home brew keg valve may be used in home brew or cornelius kegs.

The present application has been described above on the basis of one embodiment. It goes without saying that adjustments and modifications are possible, without departing from the teaching concept on which the present application is based.

One feature or aspect of an embodiment is believed at the time of the filing of this patent application to possibly reside broadly in a method of providing a fitting 3 on a container 2, the fitting being provided with a riser tube 4 which extends into the container, comprising the following steps, which are conducted at the filling plant: making available the respective fitting 3, making available a riser tube 4 of the desired length, connecting the riser-tube-forming length to the respective fitting, positioning the fitting on the container with the riser tube 4 being introduced into the container interior, and connecting the fitting to the container 1.

Another feature or aspect of an embodiment is believed at the time of the filing of this patent application to possibly reside broadly in the method, wherein the riser tube 4 is made available by separating off from a tubular or hose-like raw material or starting material 6 a length which is desired for the riser tube 4.

Yet another feature or aspect of an embodiment is believed at the time of the filing of this patent application to possibly reside broadly in the method, wherein the length separated from the stock of tube material 6 forming the riser tube 4 is fixed to the fitting 3 by gluing or welding or by non-positive or positive locking.

Still another feature or aspect of an embodiment is believed at the time of the filing of this patent application to possibly reside broadly in the method, wherein the container 1 is filled with a liquid before the fitting provided with the riser tube 4 is attached.

A further feature or aspect of an embodiment is believed at the time of the filing of this patent application to possibly reside broadly in the method, wherein the container is filled with the liquid after the attachment and fixing of the fitting provided with the riser tube 4.

Another feature or aspect of an embodiment is believed at the time of the filing of this patent application to possibly reside broadly in the method, wherein the fitting 3 is a disposable fitting.

Yet another feature or aspect of an embodiment is believed at the time of the filing of this patent application to possibly reside broadly in the method, wherein the tubular or hose-like raw material is made of plastic or metal.

Still another feature or aspect of an embodiment is believed at the time of the filing of this patent application to possibly reside broadly in the method, wherein the length forming the riser tube 4 is separated from the raw material 5 adapted to the size and/or height of the respective container in such a way that the end of the riser tube furthest from the fitting 3 is adjacent the inner surface of the container bottom when the fitting is fixed onto the container 1.

A further feature or aspect of an embodiment is believed at the time of the filing of this patent application to possibly reside broadly in the method, wherein the container is designed as a disposable container.

Another feature or aspect of an embodiment is believed at the time of the filing of this patent application to possibly reside broadly in the method, wherein the length forming the riser tube 4 is separated from the stock of tubular or hose-like starting material 5 and the riser tube 4 is connected to the respective fitting immediately prior, substantially immediately prior, essentially immediately prior, or prior to the fitting being attached to the container.

Yet another feature or aspect of an embodiment is believed at the time of the filing of this patent application to possibly reside broadly in the method, wherein the separation of the length forming the riser tube 4 from the tubular or hose-like starting material, the connection of the riser tube 4 with the fitting and the attachment of the fitting provided with the riser tube on a container 1 takes place in one and the same device or plant, in one possible embodiment, in a filling machine for filling the containers 1 with the liquid.

One feature or aspect of an embodiment is believed at the time of the filing of this patent application to possibly reside broadly in a container, in at least one possible embodiment a disposable container, with a fitting 3 fixed on a container mouth with a riser tube 4 projecting from this into the container, wherein the riser tube is formed from a length separated from a stock of a tubular or hose-like starting material.

One feature or aspect of an embodiment is believed at the time of the filing of this patent application to possibly reside broadly in a method of manufacturing and fillings kegs with beer in a keg filling plant, which keg filling plant is disposed within one sole building, said method comprising the steps of: inputting, within said sole building of said keg filling plant, into a computer, a desired number of kegs to be produced in a first run of kegs, which kegs in said first run of kegs are of a first size; determining, within said sole building of said keg filling plant, when to begin production of spears for said kegs in said first run of kegs with said computer; beginning, within said sole building of said keg filling plant, production of a first run of spears for said kegs in said first run of kegs; providing, within said sole building of said keg filling plant, a first run of fittings for kegs in said first run of kegs; each fitting in said first run of fittings being configured to connect to a coupler, such as a coupler used in home bars, commercial bars, or restaurants, and which fitting is further configured to permit flow of beer from a keg to a coupler; cutting, within said sole building of said keg filling plant, a first length of riser tube, from a stock of riser tube material, for each keg in said first run of kegs, which first length of riser tube corresponds to a keg of a first size; connecting, within said sole building of said keg filling plant, each fitting in said first run of fittings to a corresponding riser tube of said first length and producing spears in said first run of spears for kegs in said first run of kegs; producing, within said sole building of said keg filling plant, at least a portion of said spears for kegs of said first run of kegs during said first run of kegs; filling, within said sole building of said keg filling plant, each keg in said first run of kegs; each keg in said first run of kegs comprising an opening configured to receive an assembled spear; inserting, within said sole building of said keg filling plant, each spear from said first run of spears into each filled keg in said first run of kegs; connecting, within said sole building of said keg filling plant, each spear from said first run of spears to each opening of each filled keg in said first run of kegs and closing said opening; inputting, within said sole building of said keg filling plant, into a computer, a desired number of kegs to be produced in a second run of kegs, which kegs in said second run of kegs are of a second size; said second size of said kegs in said second run being different than said first size of said kegs in said first run; determining, within said sole building of said keg filling plant, prior to the conclusion of said first run of kegs, with said computer, when to stop production of spears in a first run of spears for said kegs in said first run of kegs and when to begin production of spears in a second run of spears for said kegs in said second run of kegs in order to minimize the amount of time between the conclusion of said first run of kegs and the commencement of said second run of kegs; stopping, within said sole building of said keg filling plant, production of spears for said kegs in said first run of kegs; stopping, within said sole building of said keg filling plant, filling of each keg in said first run of kegs; beginning, within said sole building of said keg filling plant, production of a second run of spears for said kegs in said second run of kegs; providing, within said sole building of said keg filling plant, a second run of fittings for kegs in said second run of kegs; each fitting in said second run of fittings being configured to connect to a coupler, such as a coupler used in home bars, commercial bars, or restaurants, and which fitting is further configured to permit flow of beer from a keg to a coupler; cutting, within said sole building of said keg filling plant, a second length of riser tube, from a stock of riser tube material, for each keg in said second run of kegs, which second length of riser tube corresponds to a keg of a second size; said second length which corresponds to a keg of a second size being different from said first length which corresponds to a keg of a first size; connecting, within said sole building of said keg filling plant, each fitting in said second run of fittings to a corresponding riser tube of said second length and producing spears in said second run of spears for kegs in said second run of kegs; producing, within said sole building of said keg filling plant, at least a portion of said spears for kegs of said second run of kegs during said second run of kegs; filling, within said sole building of said keg filling plant, each keg in said second run of kegs; each keg in said second run of kegs comprising an opening configured to receive an assembled spear; inserting, within said sole building of said keg filling plant, each spear from said second run of spears into each filled keg in said second run of kegs; connecting, within said sole building of said keg filling plant, each spear from said second run of spears to each opening of each filled keg in said second run of kegs and closing said opening; stopping, within said sole building of said keg filling plant, stopping production of spears for said kegs in said second run of kegs; and stopping, within said sole building of said keg filling plant, filling of each keg in said second run of kegs.

Another feature or aspect of an embodiment is believed at the time of the filing of this patent application to possibly reside broadly in the method, wherein: said step of cutting, within said sole building of said keg filling plant, a first length of riser tube further comprises separating, within said sole building of said keg filling plant, a first length of riser tube from a tubular or hose-like raw material or starting material; and said step of cutting, within said sole building of said keg filling plant, a second length of riser tube further comprises separating, within said sole building of said keg filling plant, a second length of riser tube from a tubular or hose-like raw material or starting material.

Yet another feature or aspect of an embodiment is believed at the time of the filing of this patent application to possibly reside broadly in the method, wherein: said step of connecting, within said sole building of said keg filling plant, each fitting in said first run of fittings to a corresponding riser tube of said first length further comprises connecting said fitting to said corresponding riser tube by at least one of: gluing; welding; non-positive locking; and positive locking; and said step of connecting, within said sole building of said keg filling plant, each fitting in said second run of fittings to a corresponding riser tube of said second length further comprises connecting said fitting to said corresponding riser tube by at least one of: gluing; welding; non-positive locking; and positive locking.

Still another feature or aspect of an embodiment is believed at the time of the filing of this patent application to possibly reside broadly in the method, wherein: said fittings in said first run of fittings comprise disposable fittings; and said fittings in said second run of fittings comprise disposable fittings.

A further feature or aspect of an embodiment is believed at the time of the filing of this patent application to possibly reside broadly in the method, wherein said tubular or hose-like raw material or starting material comprises one of: plastic and metal.

Another feature or aspect of an embodiment is believed at the time of the filing of this patent application to possibly reside broadly in the method, wherein: said first length of riser tube corresponds to a keg of a first size such that the end of said first length of riser tube, which is disposed further from said fitting, is disposed adjacent the bottom of said keg of said first size, upon said fitting being connected to said keg; and said second length of riser tube corresponds to a keg of a second size such that the end of said second length of riser tube, which is disposed further from said fitting, is disposed adjacent the bottom of said keg of said second size, upon said fitting being connected to said keg.

Yet another feature or aspect of an embodiment is believed at the time of the filing of this patent application to possibly reside broadly in the method, wherein: each keg of said first size of said first run of kegs comprises a disposable keg; and each keg of said second size of said second run of kegs comprises a disposable keg.

Still another feature or aspect of an embodiment is believed at the time of the filing of this patent application to possibly reside broadly in the method, wherein: said step of connecting, within said sole building of said keg filling plant, each fitting in said first run of fittings to a corresponding riser tube of said first length immediately prior to said steps of inserting and connecting, within said sole building of said keg filling plant, each spear from said first run of spears to each opening of each filled keg in said first run of kegs and closing said opening; said step of connecting, within said sole building of said keg filling plant, each fitting in said second run of fittings to a corresponding riser tube of said second length immediately prior to said steps of inserting and connecting, within said sole building of said keg filling plant, each spear from said second run of spears to each opening of each filled keg in said second run of kegs and closing said opening; said method further comprises performing the following steps in one machine: said step of separating, within said sole building of said keg filling plant, a first length of riser tube from a tubular or hose-like raw material or starting material, said step of connecting, within said sole building of said keg filling plant, each fitting in said first run of fittings to a corresponding riser tube of said first length, and said step of connecting, within said sole building of said keg filling plant, each spear from said first run of spears to each opening of each filled keg in said first run of kegs and closing said opening; and said step of separating, within said sole building of said keg filling plant, a second length of riser tube from a tubular or hose-like raw material or starting material, said step of connecting, within said sole building of said keg filling plant, each fitting in said second run of fittings to a corresponding riser tube of said second length, and said step of connecting, within said sole building of said keg filling plant, each spear from said second run of spears to each opening of each filled keg in said second run of kegs and closing said opening; said one machine comprises a keg filling machine configured to fill kegs with beer; and said method further comprising the steps of: inputting, within said sole building of said keg filling plant, into a computer, a desired number of kegs to be produced in a third run of kegs, which kegs in said third run of kegs are of a third size; said third size of said kegs in said third run being different than said first size of said kegs in said first run; determining, within said sole building of said keg filling plant, prior to the conclusion of said second run of kegs, with said computer, when to stop production of spears in a second run of spears for said kegs in said second run of kegs and when to begin production of spears in a third run of spears for said kegs in said third run of kegs in order to minimize the amount of time between the conclusion of said second run of kegs and the commencement of said third run of kegs; stopping, within said sole building of said keg filling plant, production of spears for said kegs in said second run of kegs; stopping, within said sole building of said keg filling plant, filling of each keg in said second run of kegs; beginning, within said sole building of said keg filling plant, production of a third run of spears for said kegs in said third run of kegs; providing, within said sole building of said keg filling plant, a third run of fittings for kegs in said third run of kegs; each fitting in said third run of fittings being configured to connect to a coupler, such as a coupler used in home bars, commercial bars, or restaurants, and which fitting is further configured to permit flow of beer from a keg to a coupler; cutting, within said sole building of said keg filling plant, a third length of riser tube, from a stock of riser tube material, for each keg in said third run of kegs, which third length of riser tube corresponds to a keg of a third size; said third length which corresponds to a keg of a third size being different from said first length which corresponds to a keg of a first size; connecting, within said sole building of said keg filling plant, each fitting in said third run of fittings to a corresponding riser tube of said third length and producing spears in said third run of spears for kegs in said third run of kegs; producing, within said sole building of said keg filling plant, at least a portion of said spears for kegs of said third run of kegs during said third run of kegs; filling, within said sole building of said keg filling plant, each keg in said third run of kegs; each keg in said third run of kegs comprising an opening configured to receive an assembled spear; inserting, within said sole building of said keg filling plant, each spear from said third run of spears into each filled keg in said third run of kegs; connecting, within said sole building of said keg filling plant, each spear from said third run of spears to each opening of each filled keg in said third run of kegs and closing said opening; stopping, within said sole building of said keg filling plant, stopping production of spears for said kegs in said third run of kegs; and stopping, within said sole building of said keg filling plant, filling of each keg in said third run of kegs.

A further feature or aspect of an embodiment is believed at the time of the filing of this patent application to possibly reside broadly in a keg made by the process according to the present application.

One feature or aspect of an embodiment is believed at the time of the filing of this patent application to possibly reside broadly in a method of manufacturing and fillings kegs with beer in a keg filling plant, which keg filling plant is disposed within one building, said method comprising the steps of: determining, within said building of said keg filling plant, a desired number of kegs to be produced in a first run of kegs, which kegs in said first run of kegs are of a first size; determining, within said building of said keg filling plant, when to begin production of spears for said kegs in said first run of kegs; beginning, within said building of said keg filling plant, production of a first run of spears for said kegs in said first run of kegs; providing, within said building of said keg filling plant, a first run of fittings for kegs in said first run of kegs; each fitting in said first run of fittings being configured to connect to a coupler, such as a coupler used in home bars, commercial bars, or restaurants, and which fitting is further configured to permit flow of beer from a keg to a coupler; cutting, within said building of said keg filling plant, a first length of riser tube, from a stock of riser tube material, for each keg in said first run of kegs, which first length of riser tube corresponds to a keg of a first size; connecting, within said building of said keg filling plant, each fitting in said first run of fittings to a corresponding riser tube of said first length and producing spears in said first run of spears for kegs in said first run of kegs; producing, within said building of said keg filling plant, at least a portion of said spears for kegs of said first run of kegs during said first run of kegs; filling, within said building of said keg filling plant, each keg in said first run of kegs; each keg in said first run of kegs comprising an opening configured to receive an assembled spear; inserting, within said building of said keg filling plant, each spear from said first run of spears into each keg in said first run of kegs; connecting, within said building of said keg filling plant, each spear from said first run of spears to each opening of each keg in said first run of kegs and closing said opening; determining, within said building of said keg filling plant, a desired number of kegs to be produced in a second run of kegs, which kegs in said second run of kegs are of a second size; said second size of said kegs in said second run being different than said first size of said kegs in said first run; determining, within said building of said keg filling plant, when to stop production of spears in a first run of spears for said kegs in said first run of kegs and when to begin production of spears in a second run of spears for said kegs in said second run of kegs; stopping, within said building of said keg filling plant, production of spears for said kegs in said first run of kegs; stopping, within said building of said keg filling plant, filling of each keg in said first run of kegs; beginning, within said building of said keg filling plant, production of a second run of spears for said kegs in said second run of kegs; providing, within said building of said keg filling plant, a second run of fittings for kegs in said second run of kegs; each fitting in said second run of fittings being configured to connect to a coupler, such as a coupler used in home bars, commercial bars, or restaurants, and which fitting is further configured to permit flow of beer from a keg to a coupler; cutting, within said building of said keg filling plant, a second length of riser tube, from a stock of riser tube material, for each keg in said second run of kegs, which second length of riser tube corresponds to a keg of a second size; said second length which corresponds to a keg of a second size being different from said first length which corresponds to a keg of a first size; connecting, within said building of said keg filling plant, each fitting in said second run of fittings to a corresponding riser tube of said second length and producing spears in said second run of spears for kegs in said second run of kegs; producing, within said building of said keg filling plant, at least a portion of said spears for kegs of said second run of kegs during said second run of kegs; filling, within said building of said keg filling plant, each keg in said second run of kegs; each keg in said second run of kegs comprising an opening configured to receive an assembled spear; inserting, within said building of said keg filling plant, each spear from said second run of spears into each keg in said second run of kegs; connecting, within said building of said keg filling plant, each spear from said second run of spears to each opening of each keg in said second run of kegs and closing said opening; stopping, within said building of said keg filling plant, production of spears for said kegs in said second run of kegs; and stopping, within said building of said keg filling plant, filling of each keg in said second run of kegs.

Another feature or aspect of an embodiment is believed at the time of the filing of this patent application to possibly reside broadly in the method, wherein: said step of cutting, within said building of said keg filling plant, a first length of riser tube further comprises separating, within said building of said keg filling plant, a first length of riser tube from a tubular or hose-like raw material or starting material; and said step of cutting, within said building of said keg filling plant, a second length of riser tube further comprises separating, within said building of said keg filling plant, a second length of riser tube from a tubular or hose-like raw material or starting material.

Yet another feature or aspect of an embodiment is believed at the time of the filing of this patent application to possibly reside broadly in the method, wherein: said step of connecting, within said building of said keg filling plant, each fitting in said first run of fittings to a corresponding riser tube of said first length further comprises connecting said fitting to said corresponding riser tube by at least one of: gluing; welding; non-positive locking; and positive locking; and said step of connecting, within said building of said keg filling plant, each fitting in said second run of fittings to a corresponding riser tube of said second length further comprises connecting said fitting to said corresponding riser tube by at least one of: gluing; welding; non-positive locking; and positive locking.

Still another feature or aspect of an embodiment is believed at the time of the filing of this patent application to possibly reside broadly in the method, wherein said method further comprises one of (A) and (B): (A) filling, within said building of said keg filling plant, each of said kegs, and then inserting, within said building of said keg filling plant, each spear into each filled keg; and (B) inserting, within said building of said keg filling plant, each spear into each keg, and then filling, within said building of said keg filling plant, each of said kegs.

A further feature or aspect of an embodiment is believed at the time of the filing of this patent application to possibly reside broadly in the method, wherein: said fittings in said first run of fittings comprise disposable fittings; and said fittings in said second run of fittings comprise disposable fittings.

Another feature or aspect of an embodiment is believed at the time of the filing of this patent application to possibly reside broadly in the method, wherein said tubular or hose-like raw material or starting material comprises one of: plastic and metal.

Yet another feature or aspect of an embodiment is believed at the time of the filing of this patent application to possibly reside broadly in the method, wherein: said first length of riser tube corresponds to a keg of a first size such that the end of said first length of riser tube, which is disposed further from said fitting, is disposed adjacent the bottom of said keg of said first size, upon said fitting being connected to said keg; and said second length of riser tube corresponds to a keg of a second size such that the end of said second length of riser tube, which is disposed further from said fitting, is disposed adjacent the bottom of said keg of said second size, upon said fitting being connected to said keg.

Still another feature or aspect of an embodiment is believed at the time of the filing of this patent application to possibly reside broadly in the method, wherein: each keg of said first size of said first run of kegs comprises a disposable keg; each keg of said second size of said second run of kegs comprises a disposable keg; said step of connecting, within said building of said keg filling plant, each fitting in said first run of fittings to a corresponding riser tube of said first length immediately prior to said steps of inserting and connecting, within said building of said keg filling plant, each spear from said first run of spears to each opening of each keg in said first run of kegs and closing said opening; said step of connecting, within said building of said keg filling plant, each fitting in said second run of fittings to a corresponding riser tube of said second length immediately prior to said steps of inserting and connecting, within said building of said keg filling plant, each spear from said second run of spears to each opening of each keg in said second run of kegs and closing said opening; said method further comprises performing the following steps in one machine: said step of separating, within said building of said keg filling plant, a first length of riser tube from a tubular or hose-like raw material or starting material, said step of connecting, within said building of said keg filling plant, each fitting in said first run of fittings to a corresponding riser tube of said first length, and said step of connecting, within said building of said keg filling plant, each spear from said first run of spears to each opening of each keg in said first run of kegs and closing said opening; and said step of separating, within said building of said keg filling plant, a second length of riser tube from a tubular or hose-like raw material or starting material, said step of connecting, within said building of said keg filling plant, each fitting in said second run of fittings to a corresponding riser tube of said second length, and said step of connecting, within said building of said keg filling plant, each spear from said second run of spears to each opening of each keg in said second run of kegs and closing said opening; said one machine comprises a keg filling machine configured to fill kegs with beer; and said method further comprising the steps of: determining, within said building of said keg filling plant, a desired number of kegs to be produced in a third run of kegs, which kegs in said third run of kegs are of a third size; said third size of said kegs in said third run being different than said first size of said kegs in said first run; determining, within said building of said keg filling plant, when to stop production of spears in a second run of spears for said kegs in said second run of kegs and when to begin production of spears in a third run of spears for said kegs in said third run of kegs; stopping, within said building of said keg filling plant, production of spears for said kegs in said second run of kegs; stopping, within said building of said keg filling plant, filling of each keg in said second run of kegs; beginning, within said building of said keg filling plant, production of a third run of spears for said kegs in said third run of kegs; providing, within said building of said keg filling plant, a third run of fittings for kegs in said third run of kegs; each fitting in said third run of fittings being configured to connect to a coupler, such as a coupler used in home bars, commercial bars, or restaurants, and which fitting is further configured to permit flow of beer from a keg to a coupler; cutting, within said building of said keg filling plant, a third length of riser tube, from a stock of riser tube material, for each keg in said third run of kegs, which third length of riser tube corresponds to a keg of a third size; said third length which corresponds to a keg of a third size being different from said first length which corresponds to a keg of a first size; connecting, within said building of said keg filling plant, each fitting in said third run of fittings to a corresponding riser tube of said third length and producing spears in said third run of spears for kegs in said third run of kegs; producing, within said building of said keg filling plant, at least a portion of said spears for kegs of said third run of kegs during said third run of kegs; filling, within said building of said keg filling plant, each keg in said third run of kegs; each keg in said third run of kegs comprising an opening configured to receive an assembled spear; inserting, within said building of said keg filling plant, each spear from said third run of spears into each keg in said third run of kegs; connecting, within said building of said keg filling plant, each spear from said third run of spears to each opening of each keg in said third run of kegs and closing said opening; stopping, within said building of said keg filling plant, production of spears for said kegs in said third run of kegs; and stopping, within said building of said keg filling plant, filling of each keg in said third run of kegs.

A further feature or aspect of an embodiment is believed at the time of the filing of this patent application to possibly reside broadly in a keg made by the process according to the present application.

The components disclosed in the various publications, disclosed or incorporated by reference herein, may possibly be used in possible embodiments of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one embodiment of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various embodiments may be used with at least one embodiment or all of the embodiments, if more than one embodiment is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications and publications recited herein, and in the Declaration attached hereto, are hereby incorporated by reference as if set forth in their entirety herein except for the exceptions indicated herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, published patent applications, and other documents which are included in this application and which are referred to in paragraphs which state “Some examples of . . . which may possibly be used in at least one possible embodiment of the present application . . . ” may possibly not be used or useable in any one or more embodiments of the application.

The sentence immediately above relates to patents, published patent applications and other documents either incorporated by reference or not incorporated by reference.

All of the patents, patent applications or patent publications, except for the exceptions indicated herein, which were cited in the International Search Report dated Jun. 12, 2008, and/or cited elsewhere are hereby incorporated by reference as if set forth in their entirety herein, as follows: U.S. Pat. No. 5,343,901, having the title “INSERTABLE BARRIER BAG OR LINER FOR A NARROW NECK DISPENSING CONTAINER AND METHOD OF FILLING SUCH A BARRIER BAG OR LINER,” published on Sep. 6, 1994; and WO 00/35803, having the title “CONTAINER FOR STORING AND DISPENSING BEVERAGE, IN PARTICULAR BEER,” published on Jun. 22, 2000.

Some examples of keg filling machines which may possibly be utilized or adapted for use in at least one possible embodiment according to the present application may possibly be the Multibloc F, the KHS Till Innokeg Transomat, the Innokeg Contikeg, the KHS Till Innokeg Keg Boy, and the Innokeg Till PETBoy F2, manufactured by KHS AG, headquartered at Juchostraβe 20, 44143, Dortmund, Germany.

Some examples of machines configured to cut pipe, which may possibly be utilized or adapted for use in at least one possible embodiment of the present application, may possibly be found in the following U.S. Pat. No. 6,981,437, having the title “Pipe cutting machine,” published on Jan. 3, 2006; U.S. Pat. No. 5,894,771, having the title “Pipe cutting machine and process for cutting pipe pieces from a pipe blank,” published on Apr. 20, 1999; U.S. Pat. No. 4,776,248, having the title “Machine for cutting pipe, tubing or the like with cutter plane adjustment,” published on Oct. 11, 1988; U.S. Pat. No. 4,430,912, having the title “Cutting apparatus and method,” published on Feb. 14, 1984; and U.S. Pat. No. 4,072,073, having the title “Machine for cutting pipe and tubing,” published on Feb. 7, 1978.

Some examples of A-system, D-system, S-system, M-system, and G-system keg valves or keg fittings, and/or A-system, D-system, S-system, M-system, and G-system keg spears, spear tubes, or riser tubes which may possibly be utilized or adapted for use in at least one possible embodiment according to the present application may be keg valves or keg fittings, and/or keg spears or spear tubes manufactured by Ruian Aobaosi Machinery Co., Ltd., headquartered at No. 33 Yanhe Road, Ruain, Zheljiang, China, 325204.

Some examples of machinery, equipment, and/or apparatuses for manufacturing keg valves or keg fittings, and/or keg spears, spear tubes, or riser tubes which may possibly be utilized or adapted for use in at least one possible embodiment according to the present application may be owned and utilized by Ruian Aobaosi Machinery Co., Ltd., headquartered at No. 33 Yanhe Road, Ruain, Zhelijiang, China, 325204.

Some examples of keg valves or keg fittings, and/or keg spears, spear tubes, or riser tubes, which may possibly be utilized or adapted for use in at least one possible embodiment according to the present application may possibly be found in the following U.S. Pat. No. 5,833,098, having the title “Spear tube for beer keg,” published on Nov. 10, 1998; U.S. Pat. No. 4,715,414, having the title “Concentric well-type extractor tube for filling containers with pressurized fluid,” published on Dec. 29, 1987; U.S. Pat. No. 5,526,965, having the title “Safety device for a beverage container valve inset,” published on Jun. 18, 1996; U.S. Pat. No. 6,308,869, having the title “Keg and keg fitting for dispensing liquids under pressure,” published on Oct. 30, 2001; U.S. Pat. No. 6,666,358, having the title “Beer container,” published on Dec. 23, 2003; U.S. Pat. No. 4,351,456, having the title “Valved keg closure,” published on Sep. 28, 1982; and U.S. Pat. No. 4,458,833, having the title “Casks and like containers,” published on Jul. 10, 1984.

Some examples of keg filling plants and/or keg filling apparatuses, which may possibly be utilized or adapted for use in at least one possible embodiment according to the present application may possibly be found in the following U.S. Pat. No. 7,455,082, having the title “Keg filling plant for filling kegs with a liquid beverage material, such as beer, wine, soft drinks, or juice, and a method of operating same, and a handling and treatment station for kegs,” published on Nov. 25, 2008; U.S. Pat. No. 5,649,575, having the title “Keg filling process and apparatus,” published on Jul. 22, 1997; U.S. Pat. No. 5,662,226, having the title “Kegging facility control process and apparatus,” published on Sep. 2, 1997; U.S. Pat. No. 3,563,287, having the title “MACHINES FOR FILLING BEER KEGS AND LIKE CONTAINERS,” published on Feb. 16, 1971; U.S. Pat. No. 4,102,450, having the title “Container washing and/or filling machines,” published on Jul. 25, 1978; U.S. Pat. No. 4,028,791, having the title “Keg handling apparatus and method,” published on Jun. 14, 1977.

U.S. patent application Ser. No. 12/209,407, filed on Sep. 9, 2008, having Attorney Docket No. NHL-HOL-169 and title “METHOD AND DEVICE FOR THE MANUFACTURE OF DISPOSABLE, ONE-WAY, SINGLE-USE BEVERAGE KEGS FOR USE IN HOME BARS;” U.S. patent application Ser. No. 12/358,892, filed on Jan. 23, 2009, having Attorney Docket No. NHL-HOL-204 and title “METHOD OF REDUCING THE VOLUME OF A NON-RETURNABLE BLOW-MOLDED BREWERY-SPECIFIC BEER KEG AND OTHER NON-RETURNABLE CONTAINERS;” and U.S. patent application Ser. No. 12/419,016, filed on Apr. 6, 2009, having Attorney Docket No. NHL-HOL-231 and title “METHOD OF STORING BEER KEGS AND DISPENSING BEER IN A COMMERCIAL BAR OR RESTAURANT, A METHOD OF STORING BEVERAGE BARRELS IN A COMMERCIAL BAR OR RESTAURANT, AND AN APPARATUS THEREFOR,” are hereby incorporated by reference as if set forth in their entirety herein.

Some examples of cameras or the like optical monitoring apparatus that may possibly be utilized or possibly adapted for use in at least one possible embodiment of the present application may possibly be found in the following U.S. Pat. No. 5,233,186 issued to Ringlien on Aug. 3, 1993; U.S. Pat. No. 5,243,400 issued to Ringlien on Sep. 7, 1993; U.S. Pat. No. 5,369,713 issued to Schwartz et al. on Nov. 29, 1994; U.S. Pat. No. 5,442,446 issued to Gerber et al. on Aug. 15, 1995; U.S. Pat. No. 5,661,295 issued to Buchmann et al. on Aug. 26, 1997; and U.S. Pat. No. 5,898,169 issued to Nodbryhn on Apr. 27, 1999.

Some examples of computer systems that may possibly be utilized or possibly adapted for use in at least one possible embodiment of the present application may possibly be found in the following U.S. Pat. No. 5,416,480 issued to Roach et al. on May 16, 1995; U.S. Pat. No. 5,479,355 issued to Hyduke on Dec. 26, 1995; U.S. Pat. No. 5,481,730 issued to Brown et al. on Jan. 2, 1996; No. 5,805,094 issued to Roach et al. on Sep. 8, 1998; No. 5,881,227 issued to Atkinson et al. on Mar. 9, 1999; and U.S. Pat. No. 6,072,462 issued to Moshovich on Jun. 6, 2000.

The patents, patent applications, and patent publications listed above in the preceding paragraphs are herein incorporated by reference as if set forth in their entirety except for the exceptions indicated herein. The purpose of incorporating U.S. patents, Foreign patents, publications, etc. is solely to provide additional information relating to technical features of one or more embodiments, which information may not be completely disclosed in the wording in the pages of this application. However, words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, ideal, need, must, only, perpetual, precise, perfect, require, requisite, simultaneous, total, unavoidable, and unnecessary, or words substantially equivalent to the above-mentioned words in this sentence, when not used to describe technical features of one or more embodiments of the patents, patent applications, and patent publications, are not considered to be incorporated by reference herein.

The corresponding foreign and international patent publication applications, namely, Federal Republic of Germany Patent Application No. 10 2007 047 060.8, filed on Oct. 1, 2007, having inventor Alois MONZEL, and DE-OS 10 2007 047 060.8 and DE-PS 10 2007 047 060.8, and International Application No. PCT/EP2008/002137, filed on Mar. 18, 2008, having WIPO Publication No. 2009/046773 A1 and inventor Alois MONZEL, are hereby incorporated by reference as if set forth in their entirety herein, except for the exceptions indicated herein, for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications and publications, except for the exceptions indicated herein, are hereby incorporated by reference as if set forth in their entirety herein.

The purpose of incorporating the corresponding foreign equivalent patent applications, that is, PCT/EP2008/002137 and German Patent Application 10 2007 047 060.8, is solely for the purpose of providing a basis of correction of any wording in the pages of the present application, which may have been mistranslated or misinterpreted by the translator. However, words relating to opinions and judgments of the author and not directly relating to the technical details of the description of the embodiments therein are not to be incorporated by reference. The words all, always, absolutely, consistently, preferably, guarantee, particularly, constantly, ensure, necessarily, immediately, endlessly, avoid, exactly, continually, expediently, ideal, need, must, only, perpetual, precise, perfect, require, requisite, simultaneous, total, unavoidable, and unnecessary, or words substantially equivalent to the above-mentioned word in this sentence, when not used to describe technical features of one or more embodiments of the patents, patent applications, and patent publications, are not generally considered to be incorporated by reference herein.

Statements made in the original foreign patent applications PCT/EP2008/002137 and DE 10 2007 047 060.8 from which this patent application claims priority which do not have to do with the correction of the translation in this patent application are not to be included in this patent application in the incorporation by reference.

Any statements about admissions of prior art in the original foreign patent applications PCT/EP2008/002137 and DE 10 2007 047 060.8 are not to be included in this patent application in the incorporation by reference, since the laws relating to prior art in non-U.S. Patent Offices and courts may be substantially different from the Patent Laws of the United States.

All of the references and documents cited in any of the documents cited herein, except for the exceptions indicated herein, are hereby incorporated by reference as if set forth in their entirety herein. All of the documents cited herein, referred to in the immediately preceding sentence, include all of the patents, patent applications and publications cited anywhere in the present application.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The details in the patents, patent applications and publications may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention. AT LEAST PARTIAL NOMENCLATURE
1 Container
2 Container head
3 Fitting
4 Riser tube
5 Container base
6 Starting or raw material for riser tube 1

What is claimed is:

1. A method of manufacturing and fillings kegs in a keg filling plant, said method comprising the steps of:
selecting or forming a riser tube of a predetermined length;
connecting said riser tube to a keg fitting, and then inserting said riser tube through an opening in a keg body, and then attaching said keg fitting at said opening to said keg body; and
filling said keg body with a liquid, either before or after attachment of said keg fitting and riser tube to said keg body.

2. The method according to claim 1, wherein said step of selecting or forming a riser tube comprises separating off a predetermined length of tube from a supply of tubular or hose-like material.

3. The method according to claim 2, wherein said step of connecting said riser tube to said keg fitting comprises at least one of: gluing, welding, non-positive locking, and positive locking.

4. The method according to claim 3, wherein said method further comprises filling said keg body with a liquid prior to inserting said riser tube and attaching said keg fitting.

5. The method according to claim 4, wherein said step of connecting said riser tube to said keg fitting comprises connecting said riser tube to a disposable keg fitting.

6. The method according to claim 5, wherein said step of separating off a predetermined length of tube comprises separating off a predetermined length of tube of plastic or metal.

7. The method according to claim 6, wherein said step of separating off a predetermined length of tube comprises separating off a length of tube which is substantially similar to the height of a keg body in which said riser tube is to be inserted, such that, upon insertion of said riser tube into said keg body, the end of said riser tube opposite said keg fitting is disposed adjacent the bottom of said body.

8. The method according to claim 7, wherein said method produces a disposable keg, and said step of connecting said riser tube to a keg fitting is performed immediately prior to said step of inserting said riser tube through said opening in said keg body.

9. The method according to claim 1, wherein said steps of selecting or forming, connecting, inserting, and then attaching are all performed in a single keg filling machine in said keg filling plant building.

10. The method according to claim 2, wherein said method further comprises filling said keg body with a liquid after inserting said riser tube and attaching said keg fitting.

11. The method according to claim 10, wherein said step of separating off a predetermined length of tube comprises separating off a length of tube which is substantially similar to the height of a keg body in which said riser tube is to be inserted, such that, upon insertion of said riser tube into said keg body, the end of said riser tube opposite said keg fitting is disposed adjacent the bottom of said keg body.

12. The method according to claim 1, wherein said step of selecting or forming a riser tube comprises selecting a riser tube of a predetermined length from a supply comprising riser tubes of various lengths which correspond to keg bodies of various heights.

13. The method according to claim 12, wherein said method further comprises filling said keg body with a liquid prior to inserting said riser tube and attaching said keg fitting.

14. The method according to claim 12, wherein said method further comprises filling said keg body with a liquid after inserting said riser tube and attaching said keg fitting.

15. The method according to claim 1, wherein said method further comprises attaching riser tubes of a first length to said keg fittings for a first run of keg bodies of a first height, and then attaching riser tubes of a different, second length to said keg fittings for a second run of keg bodies of a different, second height.

16. The method according to claim 15, wherein said step of selecting or forming a riser tube comprises:
separating off a first predetermined length of tube from a supply of tubular or hose-like material to form a riser tube of said first length; and
separating off a different, second predetermined length of tube from a supply of tubular or hose-like material to form a riser tube of said second length.

17. The method according to claim 16, wherein said method further comprises filling said keg bodies with a liquid prior to inserting said riser tubes and attaching said keg fittings.

18. The method according to claim 17, wherein said step of separating off a predetermined length of tube comprises separating off a length of tube which is substantially similar to the height of a keg body in which said riser tube is to be inserted, such that, upon insertion of said riser tube into said keg body, the end of said riser tube opposite said keg fitting is disposed adjacent the bottom of said keg body.

19. The method according to claim 18, wherein said step of connecting said riser tube to a keg fitting is performed immediately prior to said step of inserting said riser tube through said opening in said keg body, and said steps of filling, selecting or forming, connecting, inserting, and then attaching are all performed in a single keg filling machine in said keg filling plant building.

20. A disposable keg formed according to the method of claim 1, wherein said riser tube comprises a riser tube which was separated from a supply of tubular or hose-like material.
